(19) United States
(12) Patent Application Publication
(10) Pub. No.: US 2023/0295366 A1
(43) Pub. Date: Sep. 21, 2023

(54) POLYIMIDE PRECURSOR, PREPARATION METHOD THEREOF, PHOTOSENSITIVE RESIN COMPOSITION AND CURED PRODUCT

(71) Applicant: eChem Solutions Corp., Taoyuan (TW)

(72) Inventors: Wei-Chung Liang, Taoyuan (TW); Kuo-Chu Yeh, Taoyuan (TW)

(73) Assignee: eChem Solutions Corp., Taoyuan (TW)

(21) Appl. No.: 18/181,581

(22) Filed: Mar. 10, 2023

(30) Foreign Application Priority Data
Mar. 17, 2022 (TW) 111109816

(51) Int. Cl. C08F 283/04; C08G 73/10; C08G 73/12; C08F 220/20; C08F 222/10; C08J 3/28

(52) U.S. Cl. CPC C08F 283/04; C08G 73/1007; C08G 73/1078; C08G 73/12; C08F 220/20; C08F 222/102; C08J 3/28; C08J 2379/08

(57) ABSTRACT

A polyimide precursor, a preparation method thereof, a photosensitive resin composition and a cured product are provided. The polyimide precursor is obtained from a tetracarboxylic dianhydride (A), a diamine (B), and a hydroxyl-containing alkyl (meth)acrylate (C) through ring-opening substitution, and polymerization. The polyimide precursor does not include fluorine. The tetracarboxylic dianhydride (A) and the diamine (B) form a main chain. The hydroxyl-containing alkyl (meth)acrylate (C) is grafted to the main chain to form a branch. A molar ratio of the tetracarboxylic dianhydride (A) to the diamine (B) if from 1:0.95 to 1:1.10.

### CROSS-REFERENCE TO RELATED APPLICATION

This application claims the priority benefit of Taiwan application no. 111109816, filed on Mar. 17, 2022. The entirety of the above-mentioned patent application is hereby incorporated by reference herein and made a part of this specification.

### BACKGROUND

### Technical Field

The invention relates to a resin composition, and more particularly, to a polyimide precursor, a preparation method thereof, a photosensitive resin composition and a cured product.

### Description of Related Art

With the development of technology, materials with good heat resistance, such as polyimide resins, are widely used in semiconductor devices and display devices. At present, carbon trifluoride functional groups are often used to increase the penetration of polyimide precursors, so as to improve the resolution and sensitivity of the cured products prepared thereof. However, halogen-containing materials have the tendency of causing harm to the natural ecological environment and human body.

### SUMMARY

The invention provides a polyimide precursor, a preparation method thereof, a photosensitive resin composition and a cured product that may have the following characteristics: good resolution, coefficient of thermal expansion, glass transition temperature and elongation.

A polyimide precursor of the invention is obtained from a tetracarboxylic dianhydride (A), a diamine (B), and a hydroxyl-containing alkyl (meth)acrylate (C) through ring-opening substitution, and polymerization. The polyimide precursor does not include fluorine. The tetracarboxylic dianhydride (A) and the diamine (B) form a main chain. The hydroxyl-containing alkyl (meth)acrylate (C) is grafted to the main chain to form a branch. A molar ratio of the tetracarboxylic dianhydride (A) to the diamine (B) is from 1:0.95 to 1:1.10.

In an embodiment of the invention, the tetracarboxylic dianhydride (A) includes at least one of 3,3′,4,4′-diphenyl ether tetracarboxylic dianhydride, 2,3,6,7-naphthalenetetracarboxylic dianhydride, 3,3′,4,4′-diphenylsulfonetetracarboxylic dianhydride, p-phenylenebis(trimellitate anhydride), cyclobutane-1,2,3,4-tetracarboxylic dianhydride, 1,2,4,5-cyclohexanetetrcarboxylic dianhydride, 3,3′,4,4′-decahydrobiphenyltetracarboxylic dianhydride, bicyclo[2.2.2]oct-7-ene-2,3,5,6-tetra-carboxylic dianhydride (BTA), bicyclo[2.2.2]octane-2,3,5,6-tetracarboxylic dianhydride and 3,3′,4,4′-biphenyltetracarboxylic dianhydride.

In an embodiment of the invention, the diamine (B) includes at least one of 4,4′-diaminobiphenyl, p-phenylenediamine, 4,4′-oxydianiline, 2-methyl-4,4′-oxydianiline, cyclohexane-1,4-diamine, bis(4-aminocyclohexyl)methane, 1,3-bis(3-aminopropyl)-1,1,3,3-tetramethyldisiloxane and 1,9-diaminononane.

In an embodiment of the invention, the hydroxyl-containing alkyl (meth)acrylate (C) includes at least one of hydroxyethyl (meth)acrylate and glycerol 1,3-dimethacrylate.

In an embodiment of the invention, a molar ratio of the tetracarboxylic dianhydride (A) to the hydroxyl-containing alkyl (meth)acrylate (C) is from 1:0.6 to 1:2.1.

A polyimide precursor of the invention is obtained from a tetracarboxylic dianhydride (A) and a diamine (B) through polymerization reaction. The polyimide precursor does not include fluorine. The polyimide precursor includes a structural unit represented by the following Formula (1). A molar ratio of the tetracarboxylic dianhydride (A) to the diamine (B) is from 1:0.95 to 1:1.10.

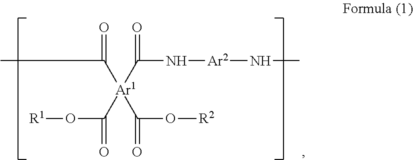

in Formula (1), Ar¹ indicates a tetravalent organic group,

Ar² indicates a divalent organic group,

R¹ and R² each indicate H,

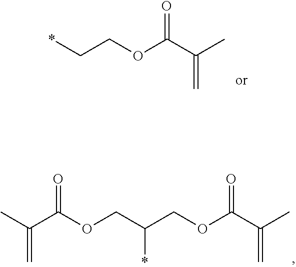

* indicates a bonding position.

In an embodiment of the invention, Ar¹ indicates

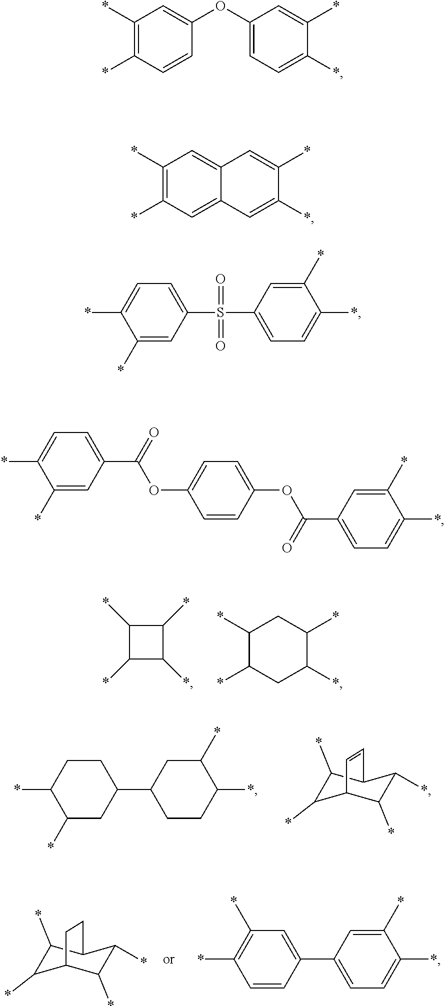

* indicates a bonding position.

In an embodiment of the invention, Ar² indicates

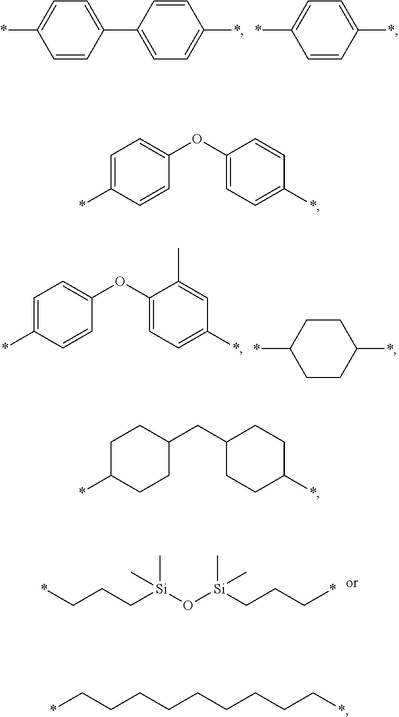

* indicates a bonding position.

In an embodiment of the invention, R¹ and R² each indicate

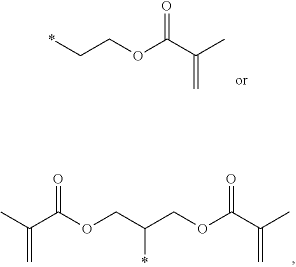

* indicates a bonding position.

In an embodiment of the invention, based on a molar fraction of 100% of a tetracarboxylic dianhydride functional group, a total molar fraction of R¹ being

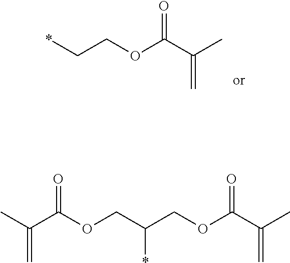

and/or R² being

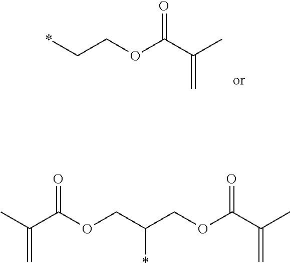

is 30% to 100%.

A preparation method of a polyimide precursor of the invention includes: performing a ring-opening substitution reaction with a tetracarboxylic dianhydride (A) and a hydroxyl-containing alkyl (meth)acrylate (C); and adding a diamine (B) to perform a polymerization reaction. The tetracarboxylic dianhydride (A) and the diamine (B) form a main chain. The hydroxyl-containing alkyl (meth)acrylate (C) is grafted to the main chain to form a branch. A molar ratio of the tetracarboxylic dianhydride (A) to the diamine (B) is from 1:0.95 to 1:1.10. The polyimide precursor does not include fluorine.

In an embodiment of the invention, the tetracarboxylic dianhydride (A) includes at least one of 3,3′,4,4′-diphenyl ether tetracarboxylic dianhydride, 2,3,6,7-naphthalenetetracarboxylic dianhydride, 3,3′,4,4′-diphenylsulfonetetracarboxylic dianhydride, p-phenylenebis(trimellitate anhydride)), cyclobutane-1,2,3,4-tetracarboxylic dianhydride, 1,2,4,5-cyclohexanetetrcarboxylic dianhydride, 3,3′,4,4′-decahydrobiphenyltetracarboxylic dianhydride, bicyclo[2.2.2]oct-7-ene-2,3,5,6-tetra-carboxylic dianhydride, bicyclo[2.2.2]octane-2,3,5,6-tetracarboxylic dianhydride and 3,3′,4,4′-biphenyltetracarboxylic dianhydride.

In an embodiment of the invention, the diamine (B) includes at least one of 4,4′-diaminobiphenyl, p-phenylenediamine, 4,4′-oxydianiline, 2-methyl-4,4′-oxydianiline, cyclohexane-1,4-diamine, bis(4-aminocyclohexyl)methane, 1,3-bis(3-aminopropyl)-1,1,3,3-tetramethyldisiloxane and 1,9-diaminononane.

In an embodiment of the invention, the hydroxyl-containing alkyl (meth)acrylate (C) includes at least one of hydroxyethyl (meth)acrylate and glycerol 1,3-dimethacrylate.

In an embodiment of the invention, a molar ratio of the tetracarboxylic dianhydride (A) to the hydroxyl-containing alkyl (meth)acrylate (C) is from 1:0.6 to 1:2.1.

A photosensitive resin composition of the invention includes the polyimide precursor above or the polyimide precursor formed by the preparation method of the polyimide precursor above.

In an embodiment of the invention, based on a total usage amount of 100 parts by weight of the photosensitive resin composition, a usage amount of the polyimide precursor is 5 parts by weight to 40 parts by weight.

In an embodiment of the invention, the photosensitive resin composition further includes at least one of a photoinitiator, a crosslinking monomer, a leveling agent, an adhesion promoter, a solvent and an additive.

In an embodiment of the invention, based on a usage amount of 100 parts by weight of the polyimide precursor, a usage amount of the photoinitiator is 1 part by weight to 30 parts by weight, a usage amount of the crosslinking monomer is 1 part by weight to 50 parts by weight, a usage amount of the solvent is 170 parts by weight to 2000 parts by weight.

A cured product of the invention is formed by the polyimide precursor above, the polyimide precursor formed by the preparation method of the polyimide precursor above or the photosensitive resin composition above.

Based on above, the polyimide precursor is formed by the polymerization of the tetracarboxylic dianhydride (A) and the diamine (B), which includes a structural unit with specific structure, does not include fluorine and for which the molar ratio of the tetracarboxylic dianhydride (A) to the diamine (B) is from 1:0.95 to 1:1.10. Thus, the photosensitive resin composition including the polyimide precursor or the cured product formed thereof has good resolution, coefficient of thermal expansion, glass transition temperature and elongation, thereby suitable for a semiconductor device and a display device.

In order to make the aforementioned features and advantages of the disclosure more comprehensible, embodiments are described in detail below.

### DESCRIPTION OF THE EMBODIMENTS

The embodiment provides a polyimide precursor, a preparation method thereof, a photosensitive resin composition including the polyimide precursor and a cured product formed thereof. Hereinafter, a detailed description is provided.

It is explained that, in the present application, the so-called “tetravalent organic group” is an organic group having four bonding positions, and the “tetravalent organic group” may form four chemical bonds through these four bonding positions.

In the present application, the so-called “divalent organic group” is an organic group having two bonding positions, and the “divalent organic group” may form two chemical bonds through these two bonding positions.

### <Polyimide Precursor>

The polyimide precursor is obtained from a tetracarboxylic dianhydride (A), a diamine (B), and a hydroxyl-containing alkyl (meth)acrylate (C) through ring-opening substitution, and polymerization, wherein the tetracarboxylic dianhydride (A) and the diamine (B) form a main chain, the hydroxyl-containing alkyl (meth)acrylate (C) is grafted to the main chain to form a branch. The polyimide precursor does not include fluorine. Hereinafter, the various monomers above are described in detail.

### Tetracarboxylic Dianhydride (A)

The tetracarboxylic dianhydride (A) is not particularly limited, and suitable tetracarboxylic dianhydride may be selected according to needs. In the present embodiment, the tetracarboxylic dianhydride (A) includes at least one of 3,3′,4,4′-diphenyl ether tetracarboxylic dianhydride, 2,3,6,7-naphthalenetetracarboxylic dianhydride, 3,3′,4,4′-diphenylsulfonetetracarboxylic dianhydride, p-phenylenebis(trimellitate anhydride)), cyclobutane-1,2,3,4-tetracarboxylic dianhydride, 1,2,4,5-cyclohexanetetrcarboxylic dianhydride, 3,3′,4,4′-decahydrobiphenyltetracarboxylic dianhydride, bicyclo[2.2.2]oct-7-ene-2,3,5,6-tetra-carboxylic dianhydride, bicyclo[2.2.2]octane-2,3,5,6-tetracarboxylic dianhydride and 3,3′,4,4′-biphenyltetracarboxylic dianhydride. In addition, in other embodiments, the tetracarboxylic dianhydride (A) may further include other suitable tetracarboxylic dianhydrides. The tetracarboxylic dianhydride (A) may be used alone or in combination. In the present embodiment, the tetracarboxylic dianhydride (A) is preferably bicyclo[2.2.2]oct-7-ene-2,3,5,6-tetra-carboxylic dianhydride, cyclobutane-1,2,3,4-tetracarboxylic dianhydride, 3,3′,4,4′-diphenyl ether tetracarboxylic dianhydride, p-phenylenebis(trimellitate anhydride) or a combination thereof.

### Diamine (B)

The diamine (B) is not particularly limited, and suitable diamine may be selected according to needs. In the present application, the diamine (B) includes at least one of 4,4′-diaminobiphenyl, p-phenylenediamine, 4,4′-oxydianiline, 2-methyl-4,4′-oxydianiline, cyclohexane-1,4-diamine, bis(4-aminocyclohexyl)methane, 1,3-bis(3-aminopropyl)-1,1,3,3-tetramethyldisiloxane and 1,9-diaminononane. In addition, in other embodiments, the diamine (B) may further include other suitable diamines. The diamine (B) may be used alone or in combination. In the present embodiment, the diamine (B) is preferably p-phenylenediamine, 4,4′-oxydianiline or a combination thereof.

The molar ratio of the tetracarboxylic dianhydride (A) to the diamine (B) is from 1:0.95 to 1:1.10, preferably from 1:1.05 to 1:1.10. When the molar ratio of the tetracarboxylic dianhydride (A) to the diamine (B) is within the above range, the photosensitive resin composition including the polyimide precursor and the cured product formed thereof have good resolution, coefficient of thermal expansion, glass transition temperature and/or elongation, and may be applied to a semiconductor device and a display device.

### Hydroxyl-Containing Alkyl (Meth)Acrylate (C)

The hydroxyl-containing alkyl (meth)acrylate (C) is not particularly limited, and suitable hydroxyl-containing alkyl (meth)acrylate may be selected according to needs. In the present embodiment, the hydroxyl-containing alkyl (meth)acrylate (C) includes at least one of hydroxyethyl (meth)acrylate and glycerol 1,3-dimethacrylate. In addition, in other embodiments, the hydroxyl-containing alkyl (meth)acrylate (C) may further include other suitable hydroxyl-containing alkyl (meth)acrylates. The hydroxyl-containing alkyl (meth)acrylate (C) may be used alone or in combination. In the present embodiment, the hydroxyl-containing alkyl (meth)acrylate (C) is preferably hydroxyethyl (meth)acrylate, more preferably hydroxyethyl methacrylate.

The molar ratio of the tetracarboxylic dianhydride (A) to the hydroxyl-containing alkyl (meth)acrylate (C) is from 1:0.6 to 1:2.1, preferably from 1:2 to 1:2.01.

<Preparation method of polyimide precursor> First, the tetracarboxylic dianhydride (A) may be performed a ring-opening substitution reaction with the hydroxyl-containing alkyl (meth)acrylate (C). Next, the diamine (B) is added for polymerization reaction to form the polyimide precursor. Thus, the polyimide precursor including a main chain and a branch may be obtained, wherein the main chain is formed by the tetracarboxylic dianhydride (A) and the diamine (B), the branch is formed by the hydroxyl-containing alkyl (meth)acrylate (C) grafted to the main chain.

The ring-opening substitution reaction and the polymerization reaction may be performed in the presence of a solvent. The solvent may include polar solvents such as γ-butyrolactone, dimethylacetamide, N-methylformamide, diethylacetamide, 1,3-dimethyl-2-imidazolidinone, N-methylcaprolactam and hexamethylphosphoric triamide. The solvent may be used alone or in combination. From the viewpoint of being environmentally friendly, the solvent is preferably diethylacetamide. From the viewpoint of solubility to the reactant, the solvent is preferably γ-butyrolactone, dimethylacetamide, diethylacetamide. However, the present embodiment is not limited thereto, and other solvents may also be selected as needed. Based on a total amount of 100 parts by weight of the tetracarboxylic dianhydride, the diamine and the solvent for synthesizing the polyimide precursor, the content of the solvent used in the polymerization reaction may be 30 parts by weight to 80 parts by weight, preferably 40 parts by weight to 50 parts by weight.

The temperature of the ring-opening substitution reaction may be 30° C. to 60° C., the time of that may be 4 hours to 24 hours. The temperature of the polymerization reaction may be 25° C. to 50° C., the time of that may be 4 hours to 12 hours.

According to a polyimide precursor of the present embodiment, wherein the polyimide precursor includes a structural unit represented by the following Formula (1).

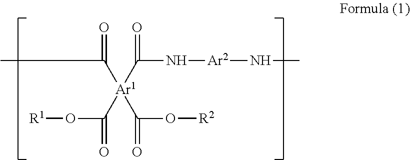

in Formula (1), Ar¹ indicates a tetravalent organic group,

Ar² indicates a divalent organic group,

R¹ and R² each indicate H,

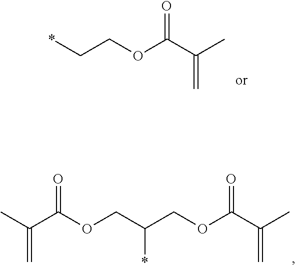

* indicates a bonding position.

The tetravalent organic group represented by Ar¹ may be derived from the tetracarboxylic dianhydride (A) above. In an embodiment, Ar¹ may indicate

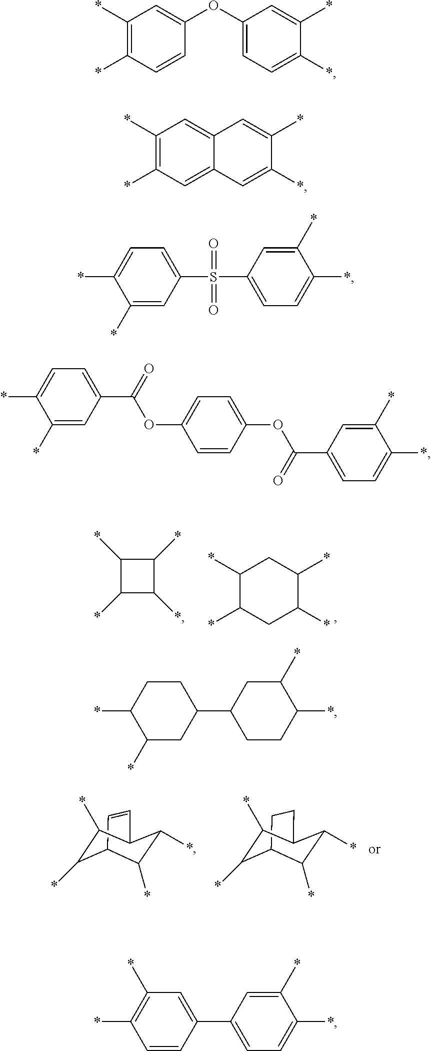

* indicates a bonding position; preferably

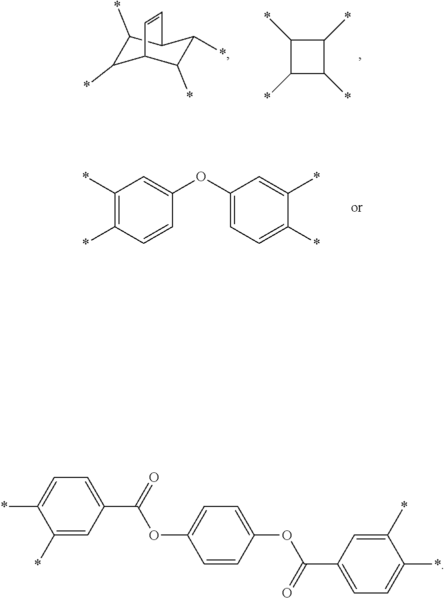

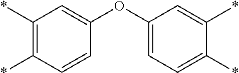 [SMILES: *c1ccc(Oc2ccc(*)c(*)c2)cc1*]

group may be derived from 3,3′,4,4′-diphenyl ether tetracarboxylic dianhydride.

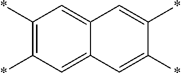 [SMILES: *c1cc2cc(*)c(*)cc2cc1*]

group may be derived from 2,3,6,7-naphthalenetetracarboxylic dianhydride.

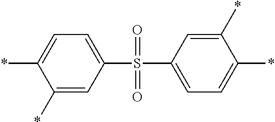 [SMILES: *c1ccc(S(=O)(=O)c2ccc(*)c(*)c2)cc1*]

group may be derived from 3,3′,4,4′-diphenylsulfonetetracarboxylic dianhydride.

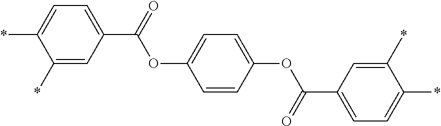 [SMILES: *c1ccc(C(=O)Oc2ccc(OC(=O)c3ccc(*)c(*)c3)cc2)cc1*]

group may be derived from p-phenylenebis(trimellitate anhydride).

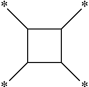 [SMILES: *C1C(*)C(*)C1*]

group may be derived from cyclobutane-1,2,3,4-tetracarboxylic dianhydride.

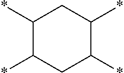 [SMILES: *C1CC(*)C(*)CC1*]

group may be derived from 1,2,4,5-cyclohexanetetrcarboxylic dianhydride.

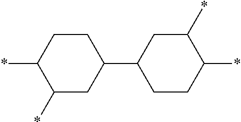 [SMILES: *C1CCC(C2CCC(*)C(*)C2)CC1*]

group may be derived from 3,3′,4,4′-decahydrobiphenyltetracarboxylic dianhydride.

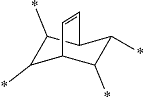 [SMILES: *C1C(*)C2C=CC1C(*)C2*]

group may be derived from bicyclo[2.2.2]oct-7-ene-2,3,5,6-tetra-carboxylic dianhydride.

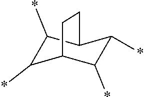 [SMILES: *C1C(*)C2CCC1C(*)C2*]

group may be derived from bicyclo[2.2.2]octane-2,3,5,6-tetracarboxylic dianhydride.

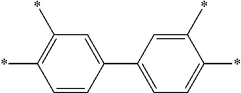 [SMILES: *c1ccc(-c2ccc(*)c(*)c2)cc1*]

group may be derived from 3,3′,4,4′-biphenyltetracarboxylic dianhydride.

The divalent organic group represented by Ar² may be derived from the diamine (B) above. In an embodiment, Ar² may indicate

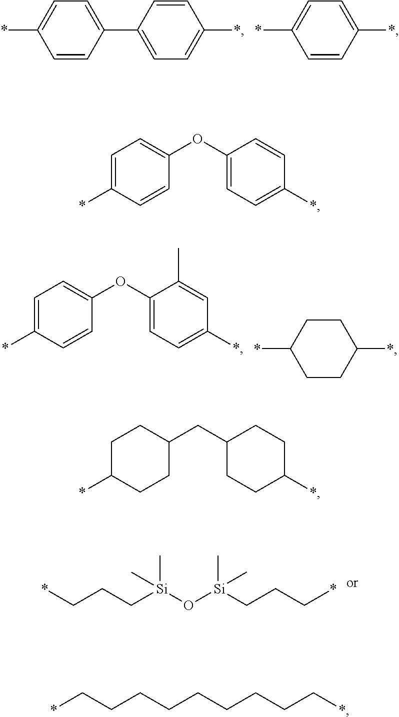

* indicates a bonding position; preferably

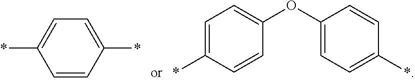

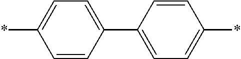 [SMILES: *c1ccc(-c2ccc(*)cc2)cc1]

group may be derived from 4,4′-diaminobiphenyl.

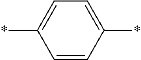 [SMILES: *c1ccc(*)cc1]

group may be derived from p-phenylenediamine.

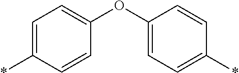 [SMILES: *c1ccc(Oc2ccc(*)cc2)cc1]

group may be derived from 4,4′-oxydianiline.

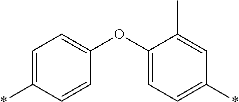 [SMILES: *c1ccc(Oc2ccc(*)cc2C)cc1]

group may be derived from 2-methyl-4,4′-oxydianiline.

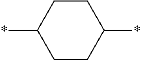 [SMILES: *C1CCC(*)CC1]

group may be derived from cyclohexane-1,4-diamine.

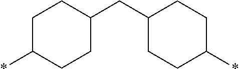 [SMILES: *C1CCC(CC2CCC(*)CC2)CC1]

group may be derived from bis(4-aminocyclohexyl)methane.

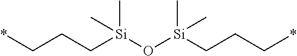 [SMILES: *CCC[Si](C)(C)O[Si](C)(C)CCC*]

group may be derived from 1,3-bis(3-aminopropyl)-1,1,3,3-tetramethyldisiloxane.

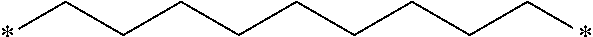 [SMILES: *CCCCCCCCC*]

group may be derived from 1,9-diaminononane.

The group respectively represented by R¹ and R² may be derived from the hydroxyl-containing alkyl (meth)acrylate (C) above. In an embodiment, R¹ and R² each indicate

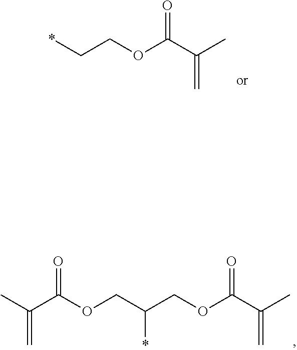

* indicates a bonding position; preferably

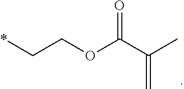 [SMILES: *CCOC(=O)C(=C)C]

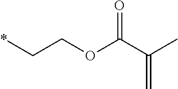 [SMILES: *CCOC(=O)C(=C)C]

group may be derived from hydroxyethyl (meth)acrylate.

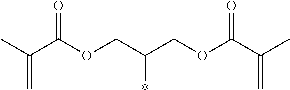 [SMILES: *C(COC(=O)C(=C)C)COC(=O)C(=C)C]

group may be derived from glycerol 1,3-dimethacrylate.

In an embodiment, based on a molar fraction of 100% of a tetracarboxylic dianhydride functional group, a total molar fraction of R¹ being or

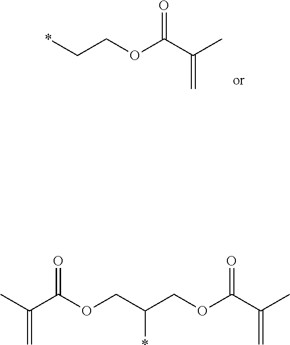

and/or R² being

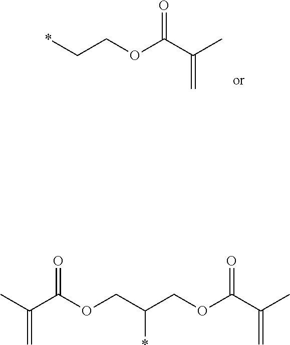

is 30% to 100%, preferably 95% to 100%. When the total molar fraction of R¹ and/or R² being

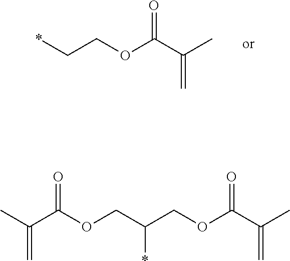

is within the above range, the photosensitive resin composition including the polyimide precursor and the cured product formed thereof have good resolution, coefficient of thermal expansion, glass transition temperature and elongation, and may be applied to a semiconductor device and a display device. When the total molar fraction of R¹ and/or R² being

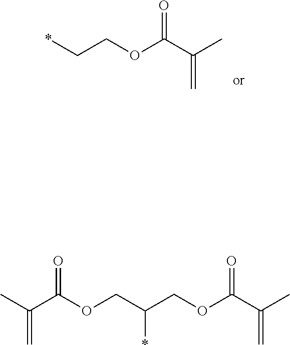

is out of the above range, the photosensitive resin composition including the polyimide precursor and the cured product formed thereof cannot have good resolution, coefficient of thermal expansion, glass transition temperature and elongation at the same time, and may be not applied to a semiconductor device and a display device. Furthermore, when the total molar fraction of R¹ and/or R² being

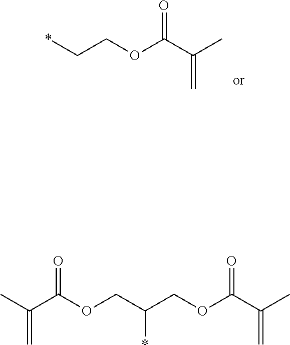

is less than 30%, the resolution, coefficient of thermal expansion, glass transition temperature and elongation of the photosensitive resin composition including the polyimide precursor and the cured product formed thereof are all poor.

### <Photosensitive Resin Composition>

An exemplary embodiment of the present invention provides a photosensitive resin composition including the polyimide precursor in any of the embodiments above. Based on a total usage amount of 100 parts by weight of the photosensitive resin composition, a usage amount of the polyimide precursor is 5 parts by weight to 40 parts by weight, preferably 24.0 parts by weight to 34.5 parts by weight.

In addition, the photosensitive resin composition may include at least one of a photoinitiator, a crosslinking monomer, a leveling agent, an adhesion promoter, a solvent and an additive. Moreover, the method of forming the photosensitive resin composition is not particularly limited, for example, it is sufficient to continue stirring using a stirring device until each component in the photosensitive resin composition is uniformly dispersed.

The photoinitiator is not particularly limited, and suitable photoinitiator may be selected according to needs. For example, the photoinitiator may include an oxime ester-based photoinitiator which may generate a free radical. The oxime ester-based photoinitiator may include Irgacure OXE-01, OXE-02, OXE-03 (product name; made by BASF), Photocure 4456 (product name; made by Eutec Chemical Co., Ltd.), FS-668 (product name; made by Changzhou Tronly New Electronic Materials Co., Ltd.), TR-PBG-358 (product name; made by Changzhou Tronly New Electronic Materials Co., Ltd.), TR-PBG-345 (product name; made by Changzhou Tronly New Electronic Materials Co., Ltd.) or other suitable oxime ester-based compounds. The photoinitiator may be used alone or in combination. In the present embodiment, the photoinitiator is preferably Irgacure OXE-01 (product name). Based on the usage amount of 100 parts by weight of the polyimide precursor, a usage amount of the photoinitiator is 1 part by weight to 30 parts by weight, preferably 2 parts by weight to 13 parts by weight.

The crosslinking monomer is not particularly limited, and suitable crosslinking monomer may be selected according to needs. For example, the cross-linking monomer may include a compound including two or more branch and a carbon-carbon unsaturated bond functional group at the end. The crosslinking monomer may include dipentaerythritol hexaacrylate (DPHA), poly(ethylene glycol) diacrylate, 9,9-bis[4-(2-acryloyloxyethyloxy)phenyl] fluorene, UX-5000 (product name; made by Shenzhen Sapience Technology Co., Ltd.), pentaerythritol tetrakis (3-mercaptobutylate) or other suitable crosslinking monomer. The crosslinking monomer may be used alone or in combination. In the present embodiment, the crosslinking monomer is preferably dipentaerythritol hexaacrylate, UX-5000 (product name), pentaerythritol tetrakis (3-mercaptobutylate) or a combination thereof. Based on the usage amount of 100 parts by weight of the polyimide precursor, a usage amount of the crosslinking monomer is 1 part by weight to 50 parts by weight, preferably 1 part by weight to 15 parts by weight, more preferably 9 parts by weight to 13 parts by weight.

The leveling agent is not particularly limited, and suitable leveling agent may be selected according to needs, for example, a leveling agent which may let the photosensitive resin composition be uniformly coated. For example, the leveling agent may be a leveling agent that does not include salt. The leveling agent may include TEGO® Glide ZG 400 (product name; made by Evonik Industries), BYK-3455 (product name; made by BYK-Chemie GmbH) or other suitable leveling agents. The leveling agent may be used alone or in combination.

The adhesion promoter is not particularly limited, and suitable adhesion promoter may be selected according to needs, for example, an adhesion promoter which may provide good adhesion between the cured product formed by the photosensitive resin composition and the substrate. For example, the adhesion promoter may include an organic compound including a siloxane functional group. The adhesion promoter may include 1,3,5-tris(3-trimethoxysilylpropyl)-1,3,5-triazine-2,4,6(1H,3H,5H)-trione, 3-methacryloxypropyl trimethoxysilane, GENIOSIL GF20 (product name; made by Wacker Chemicals Co., Ltd.), CB-660M (product name; made by Chembridge International Corp, Ltd.), VD-5 (product name; made by Shikoku Chemicals Corporation), DMS-V46 (product name; made by Gelest Inc.) or other suitable adhesion promoters. The adhesion promoter may be used alone or in combination.

The solvent is not particularly limited, and suitable solvent may be selected according to needs, for example, a solvent which may dissolve the polyimide precursor, let the photosensitive resin composition be uniformly mixed and may not react with each component in the photosensitive resin composition. For example, the solvent may include γ-butyrolactone (GBL), dimethylacetamide (DMAc), N-methylformamide, diethylacetamide, 1,3-dimethyl-2-imidazolidinone, N-methylcaprolactam, hexamethylphosphoric triamide or other suitable solvents. The solvent may be used alone or in combination. In the present embodiment, the solvent is preferably γ-butyrolactone, dimethylacetamide, diethylacetamide. Based on the usage amount of 100 parts by weight of the polyimide precursor, a usage amount of the solvent is 170 parts by weight to 2000 parts by weight, preferably 170 parts by weight to 400 parts by weight.

The additive is not particularly limited, and suitable additive may be selected according to needs. For example, the additive may include a polyimide precursor having different structures from the polyimide precursor above, a non-polyimide precursor polymer, an azole-based compound, a free radical inhibitor, a sensitizer, an aromatic anhydride compound or other suitable additives. The additive may be used alone or in combination. The free radical inhibitor may include 4-methoxyphenol (MEHQ), hydroquinone (HQ) or a combination thereof. Other additives are such as benzotriazole. Based on the usage amount of 100 parts by weight of the polyimide precursor, a usage amount of the additive is 1.0 part by weight to 4.5 parts by weight, preferably 1.1 parts by weight to 4.3 parts by weight.

### <Cured Product>

An exemplary embodiment of the present invention provides a cured product, which is formed by the polyimide precursor above or the photosensitive resin composition above.

The cured product may be formed by coating the polyimide precursor or the photosensitive resin composition on a substrate to form a coating film and performing pre-bake, exposure, development, and post-bake on the coating film. For example, after the photosensitive resin composition was coated on the substrate to form a coating film, the baking step before the exposure (i.e. pre-bake) was performed at a temperature of 100° C. for 3 minutes. Next, the pre-baked coating film was exposed with light of 300 mJ/cm² using a stepper. Then, the exposed coating film was performed with a step of development for 60 seconds to 300 seconds. Next, developed coating film was washed with propylene glycol methyl ether acetate (PGMEA) and nitrogen gas was blown to dry the coating film. Then, post-bake was performed at 280° C. for 120 minutes to form a cured product with a thickness of 10 μm on the substrate.

The substrate may be a glass substrate, a plastic base material (such as a polyether sulfone (PES) board, a polycarbonate (PC) board or a polyimide (PI) film) or other transparent substrates, and the type thereof is not particularly limited.

The coating method is not particularly limited, but a spray coating method, a roll coating method, a spin coating method, or the like may be used, and in general, a spin coating method is widely used. In addition, a coating film was formed, and then, in some cases, the residual solvent may be partially removed under reduced pressure.

The developing solution is not particularly limited, and a suitable developing solution may be selected according to needs. For example, the developing solution may be cyclopentanone (CPN) solution.

Hereinafter, the invention is described in detail with reference to examples. The following examples are provided to describe the invention, and the scope of the invention includes the scope in the following patent application and its substitutes and modifications, and is not limited to the scope of the examples.

### Examples of Polyimide Precursor, Photosensitive Resin Composition and Cured Product

Preparation example 1 to Preparation example 17 of the polyimide precursor, Example 1 to Example 13 and Comparative example 1 to Comparative example 7 of the photosensitive resin composition and the cured product are described below:

a. Preparation Example 1 of Polyimide Precursor

24.98 mmol of bicyclo[2.2.2]oct-7-ene-2,3,5,6-tetra-carboxylic dianhydride (BTA) and 49.96 mmol of hydroxyethyl methacrylate were added into a round-bottomed reaction flask, and then adding 60 mL of tetrahydrofuran to stir. After the reaction flask was turbid and stirred for 5 minutes, 50.43 mmol of 4-dimethylaminopyridine was quickly poured into the reaction flask and rapidly stirred to heat the reaction to a reflux state. The inside of the reaction flask was gradually clear over time. After the reaction was left overnight, a white solid formed in the reaction flask. After removing most of the tetrahydrofuran by rotary evaporation method, it was extracted with ethyl acetate and 1 N hydrochloric acid. 4-dimethylaminopyridine was extracted to the aqueous layer, and the organic layer was extracted with aqueous sodium carbonate to extract the product to the aqueous layer. Next, the aqueous layer was acidified with 1 N hydrochloric acid, and then the product was extracted into the organic layer with ethyl acetate. Then, after concentrating the organic layer, a viscous colloidal product may be obtained. Evacuate the reaction flask including the viscous colloidal product to a foaming state to obtain a photosensitive group-containing dicarboxylic acid monomer (white solid product). The white solid product was kept under nitrogen. 30 mL of thionyl chloride was slowly dropped into the reaction flask with the photosensitive group-containing dicarboxylic acid monomer, and stirred in an ice bath for 30 minutes; then the ice bath was removed and the reaction flask was placed at room temperature to react for 4 hours. The reaction solution was concentrated under reduced pressure to remove excess thionyl chloride. The colloid obtained after concentration was dissolved in 15 mL of N-methylpyrrolidone, then 26.16 mmol of p-phenylenediamine was poured into, and stirred for 30 minutes in an ice bath. 49.96 mmol of pyridine was slowly dropped into the reaction flask; after stirring vigorously, the reaction was performed at room temperature for 18 hours. After diluting the mixed solution in the reaction flask with an appropriate amount of N-methylpyrrolidone, it was dropped into vigorously stirred water to precipitate a polyimide precursor. After filtering and vacuum drying at 35° C. for 24 hours, the polyimide precursor P1 of Preparation Example 1 was obtained.

### Example 1

b. Photosensitive Resin Composition

24.23 parts by weight of polyimide precursor P1, 0.71 part by weight of Irgacure OXE-01 (product name; made by BASF), 2.38 parts by weight of dipentaerythritol hexaacrylate and 0.40 part by weight of 4-methoxyphenol were added to 72.28 parts by weight of dimethylacetamide, and after stirring uniformly with a stirrer, the photosensitive resin composition of Example 1 was obtained.

c. Cured Product

The photosensitive resin composition prepared in the Example 1 was coated on a glass substrate by a spin coating method (spin coater model: MS-A150, manufactured by MIKASA Corporation, rotation speed: about 500 rpm to 3000 rpm). Next, pre-bake was performed at a temperature of 100° C. for 3 minutes to form a wet film with a thickness of 13 μm to 18 μm. Then, exposure to the pre-baked thin film was performed at 300 mJ/cm² using a stepper (model: FPA 5500iZa, manufactured by Canon Inc.) to form a semi-finished product. Next, development was performed at a temperature of 25° C. using cyclopentanone (CPN) as a developing solution for 60 seconds to 300 seconds. Then, the developed coating film was washed with propylene glycol methyl ether acetate (PGMEA). Next, in an oven filled with nitrogen, the temperature was increased at a rate of 10° C. per minute until the temperature reached 280° C., then maintained at 280° C. for post-baking for 120 minutes, and then decreased at a rate of 10° C. per minute. A cured product with a pattern thickness of 10 μm was obtained. After peeling off the obtained cured product from the substrate, it was evaluated by each of the following evaluation methods, and the results thereof are as shown in Table 4 to Table 5.

### Example 2 to Example 13 and Comparative Example 1 to Comparative Example 7

The polyimide precursor and the photosensitive resin compositions of Example 2 to Example 13 and Comparative example 1 to Comparative example 7 were prepared using the same steps as Example 1, and the difference thereof is: the type and the usage amount of the components of the polyimide precursor and the photosensitive resin compositions were changed (as shown in Table 2 and Table 3), wherein the components/compounds corresponding to the symbols in Table 2 and Table 3 are shown in Table 1. The obtained photosensitive resin compositions were made into cured products and evaluated by each of the following evaluation methods, and the results thereof are as shown in Table 4 and Table 5.

TABLE 1

| | Symbol | Components/compound |
|---|---|---|
| Tetracarboxylic | A-1 | Bicyclo[2.2.2]oct-7-ene-2,3,5,6- |
| dianhydride (A) | | tetra-carboxylic dianhydride |
| | A-2 | Cyclobutane-1,2,3,4- |
| | | tetracarboxylic dianhydride |
| | A-3 | 3,3′,4,4′-diphenyl ether |
| | | tetracarboxylic dianhydride |
| | A-4 | p-Phenylenebis(trimellitate |
| | | anhydride)) |
| | A-5 | Pyromellitic dianhydride |
| | A-6 | 3,3′,4,4′-Biphenyltetracarboxylic |
| | | dianhydride |
| | A-7 | 3,3′,4,4′-Benzophenonetetra- |
| | | carboxylic dianhydride |
| Diamine (B) | B-1 | p-Phenylenediamine |
| | B-2 | 4,4′-Oxydianiline |
| Hydroxyl-containing | C-1 | Hydroxyethyl methacrylate |
| alkyl (meth)acrylate (C) | C-2 | Glycerol 1,3-dimethacrylate |
| Polyimide precursor (P) | P-1 | Polyimide precursor P1 |
| | P-2 | Polyimide precursor P2 |
| | P-3 | Polyimide precursor P3 |
| | P-4 | Polyimide precursor P4 |
| | P-5 | Polyimide precursor P5 |
| | P-6 | Polyimide precursor P6 |
| | P-7 | Polyimide precursor P7 |
| | P-8 | Polyimide precursor P8 |
| | P-9 | Polyimide precursor P9 |
| | P-10 | Polyimide precursor P10 |
| | P-11 | Polyimide precursor P11 |
| | P-12 | Polyimide precursor P12 |
| | P-13 | Polyimide precursor P13 |
| | P-14 | Polyimide precursor P14 |
| | P-15 | Polyimide precursor P15 |
| | P-16 | Polyimide precursor P16 |
| | P-17 | Polyimide precursor P17 |
| Photoinitiator (Q) | Q-1 | Irgacure OXE-01 (product name; |
| | | made by BASF) |
| Crosslinking monomer | R-1 | Dipentaerythritol hexaacrylate |
| (R) | | (DPHA) |
| | R-2 | UX-5000 (product name; made by |
| | | Shenzhen Sapience Technology |
| | | Co., Ltd.) |
| | R-3 | pentaerythritol tetrakis |
| | | (3-mercaptobutylate) |
| | R-4 | 2-[N-(Methoxymethyl)amino]-4- |
| | | (N-hydroxymethyl-N- |
| | | methoxymethyl)amino-6-N,N- |
| | | di(methoxymethyl)-1,3,5-triazine |
| | R-5 | Triallyl isocyanurate |
| | R-6 | Polyurethane Acrylate Oligomer |
| | | (product name: CN-9014-NS; |
| | | made by TOYO CHEMICAL |
| | | FACTORY LTD.) |
| Solvent (U) | U-1 | Dimethylacetamide |
| | U-2 | γ-butyrolactone |
| Additive (V) | V-1 | 4-Methoxyphenol |
| | V-2 | Hydroquinone |
| | V-3 | Benzotriazole |
| | V-4 | 9-Anthrylmethyl-N,N- |
| | | diethylcarbamate |

TABLE 2

| Component | | Polyimide precursors | | | | | | | | |
|---|---|---|---|---|---|---|---|---|---|---|
| (unit: mmol) | | P1 | P2 | P3 | P4 | P5 | P6 | P7 | P8 | P9 |
| Tetra- | A-1 | 24.98 | 24.98 | 18.72 | 12.49 | 12.49 | — | — | — | — |
| carboxylic | A-2 | — | — | 6.24 | 12.49 | — | 24.98 | 24.98 | — | — |
| dianhydride | A-3 | — | — | — | — | 12.49 | — | — | 24.98 | 24.98 |
| (A) | A-4 | — | — | — | — | — | — | — | — | — |
| | A-5 | — | — | — | — | — | — | — | — | — |
| | A-6 | — | — | — | — | — | — | — | — | — |
| | A-7 | — | — | — | — | — | — | — | — | — |
| Diamine | B-1 | 26.16 | — | — | — | — | 26.16 | — | — | 26.16 |
| (B) | B-2 | — | 26.16 | 26.16 | 26.16 | 26.16 | — | 26.16 | 26.16 | — |
| Molar ratio of | | 1:1.05 | 1:1.05 | 1:1.05 | 1:1.05 | 1:1.05 | 1:1.05 | 1:1.05 | 1:1.05 | 1:1.05 |
| tetracarboxylic | | | | | | | | | | |
| dianhydride (A) | | | | | | | | | | |
| to diamine (B) | | | | | | | | | | |
| Hydroxyl- | C-1 | 49.96 | 49.96 | 49.96 | 49.96 | 49.96 | 49.96 | 49.96 | 49.96 | — |
| containing | | | | | | | | | | |
| alkyl (meth) | C-2 | | — | — | — | — | — | — | — | 49.96 |
| acrylate (C) | | | | | | | | | | |

| Component | | Polyimide precursors | | | | | | | |
|---|---|---|---|---|---|---|---|---|---|
| (unit: mmol) | | P10 | P11 | P12 | P13 | P14 | P15 | P16 | P17 |
| Tetra- | A-1 | — | — | — | — | — | — | — | — |
| carboxylic | A-2 | — | — | — | 12.49 | — | — | — | — |
| dianhydride | A-3 | — | — | — | — | 12.49 | — | — | — |
| (A) | A-4 | 24.98 | — | — | — | — | — | — | — |
| | A-5 | — | 24.98 | 24.98 | 12.49 | 12.49 | — | — | — |
| | A-6 | — | — | — | — | — | 24.98 | 24.98 | — |
| | A-7 | — | — | — | — | — | — | — | 24.98 |
| Diamine | B-1 | 26.16 | 26.16 | | 26.16 | 26.16 | 26.16 | — | — |
| (B) | B-2 | — | — | 26.16 | — | — | — | 26.16 | 26.16 |
| Molar ratio of | | 1:1.05 | 1:1.05 | 1:1.05 | 1:1.05 | 1:1.05 | 1:1.05 | 1:1.05 | 1:1.05 |
| tetracarboxylic | | | | | | | | | |
| dianhydride | | | | | | | | | |
| (A) to | | | | | | | | | |
| diamine (B) | | | | | | | | | |
| Hydroxyl- | C-1 | 49.96 | 49.96 | 49.96 | 49.96 | 49.96 | 49.96 | 49.96 | 49.96 |
| containing | | | | | | | | | |
| alkyl(meth) | C-2 | — | — | — | — | — | — | — | — |
| acrylate (C) | | | | | | | | | |

TABLE 3

| Component | | Examples | | | | | | |
|---|---|---|---|---|---|---|---|---|
| (unit: parts by weight) | | 1 | 2 | 3 | 4 | 5 | 6 | 7 |
| Polyimide | P-1 | 24.23 | — | — | — | — | — | — |
| precursor (P) | P-2 | — | 24.23 | — | — | — | — | — |
| | P-3 | — | — | 24.23 | — | — | — | — |
| | P-4 | — | — | — | 24.23 | — | — | — |
| | P-5 | — | — | — | — | 24.23 | — | — |
| | P-6 | — | — | — | — | — | 24.23 | — |
| | P-7 | — | — | — | — | — | — | 24.23 |
| | P-8 | — | — | — | — | — | — | — |
| | P-9 | — | — | — | — | — | — | — |
| | P-10 | — | — | — | — | — | — | — |
| | P-11 | — | — | — | — | — | — | — |
| | P-12 | — | — | — | — | — | — | — |
| | P-13 | — | — | — | — | — | — | — |
| | P-14 | — | — | — | — | — | — | — |
| | P-15 | — | — | — | — | — | — | — |
| | P-16 | — | — | — | — | — | — | — |
| | P-17 | — | — | — | — | — | — | — |
| Photoinitiator (Q) | Q-1 | 0.71 | 0.71 | 0.71 | 0.71 | 0.71 | 0.71 | 0.71 |
| Crosslinking | R-1 | 2.38 | 2.38 | 2.38 | 2.38 | 2.38 | 2.38 | 2.38 |
| monomer (R ) | R-2 | — | — | — | — | — | — | — |
| | R-3 | — | — | — | — | — | — | — |
| | R-4 | — | — | — | — | — | — | — |
| | R-5 | — | — | — | — | — | — | — |
| | R-6 | — | — | — | — | — | — | — |
| Solvent (U) | U-1 | 72.28 | 72.28 | 72.28 | 72.28 | 72.28 | 72.28 | 72.28 |
| | U-2 | — | — | — | — | — | — | — |
| Additive (V) | V-1 | 0.40 | 0.40 | 0.40 | 0.40 | 0.40 | 0.40 | 0.40 |
| | V-2 | — | — | — | — | — | — | — |
| | V-3 | — | — | — | — | — | — | — |
| | V-4 | — | — | — | — | — | — | — |
| Component | | Examples | | | | | | |
| (unit: parts by weight) | | 8 | 9 | 10 | 11 | 12 | 13 | |
| Polyimide | P-1 | — | — | — | — | — | — | |
| precursor (P) | P-2 | — | — | — | — | — | — | |
| | P-3 | — | — | — | — | — | — | |
| | P-4 | — | — | — | — | 34.37 | — | |
| | P-5 | — | — | — | — | — | — | |
| | P-6 | — | — | — | — | — | — | |
| | P-7 | — | — | — | 29.25 | — | — | |
| | P-8 | 24.23 | — | — | — | — | — | |
| | P-9 | — | 28.00 | — | — | — | — | |
| | P-10 | — | — | 28.00 | — | — | — | |
| | P-11 | — | — | — | — | — | — | |
| | P-12 | — | — | — | — | — | — | |
| | P-13 | — | — | — | — | — | — | |
| | P-14 | — | — | — | — | — | — | |
| | P-15 | — | — | — | — | — | 28.00 | |
| | P-16 | — | — | — | — | — | — | |
| | P-17 | — | — | — | — | — | — | |
| Photoinitiator (Q) | Q-1 | 0.71 | 3.40 | 3.40 | 0.83 | 1.57 | 3.40 | |
| Crosslinking | R-1 | 2.38 | — | 1.70 | 2.77 | 3.27 | — | |
| monomer (R) | R-2 | — | 2.72 | 1.70 | — | — | 2.72 | |
| | R-3 | — | 0.68 | — | — | — | 0.68 | |
| | R-4 | — | — | — | 0.15 | 0.40 | — | |
| | R-5 | — | — | — | — | — | — | |
| | R-6 | — | — | — | — | — | — | |
| Solvent (U) | U-1 | 72.28 | 54.00 | 54.00 | 67.00 | 60.00 | 54.00 | |
| | U-2 | — | 10.00 | 10.00 | — | — | 10.00 | |
| Additive (V) | V-1 | 0.40 | — | — | — | — | — | |
| | V-2 | — | 0.20 | 0.20 | — | — | 0.20 | |
| | V-3 | — | 1.00 | 1.00 | — | — | 1.00 | |
| | V-4 | — | — | — | — | 0.39 | — | |
| Component | | Comparative examples | | | | | | |
| (unit: parts by weight) | | 1 | 2 | 3 | 4 | 5 | 6 | 7 |
| Polyimide | P-1 | — | — | — | — | — | — | — |
| precursor (P) | P-2 | — | — | — | — | — | — | — |
| | P-3 | — | — | — | — | — | — | — |
| | P-4 | — | — | — | — | — | — | — |
| | P-5 | — | — | — | — | — | — | — |
| | P-6 | — | — | — | — | — | — | — |
| | P-7 | — | — | — | — | — | — | — |
| | P-8 | — | — | — | — | — | — | — |
| | P-9 | — | — | — | — | — | — | — |
| | P-10 | — | — | — | — | — | — | — |
| | P-11 | 35.31 | — | — | — | — | — | — |
| | P-12 | — | 35.31 | — | — | — | — | — |
| | P-13 | — | — | 35.31 | — | — | — | — |
| | P-14 | — | — | — | 34.02 | — | — | — |
| | P-15 | — | — | — | — | 35.31 | — | — |
| | P-16 | — | — | — | — | — | 35.31 | — |
| | P-17 | — | — | — | — | — | — | 28.11 |
| Photoinitiator (Q) | Q-1 | 1.04 | 1.04 | 1.04 | 1.66 | 1.04 | 1.04 | 3.07 |
| Crosslinking | R-1 | — | — | — | 1.66 | — | — | — |
| monomer (R) | R-2 | — | — | — | — | — | — | 2.73 |
| | R-3 | — | — | — | — | — | — | 0.68 |
| | R-4 | — | — | — | — | — | — | — |
| | R-5 | 3.45 | 3.45 | 3.45 | — | 3.45 | 3.45 | — |
| | R-6 | — | — | — | 1.66 | — | — | — |
| Solvent (U) | U-1 | 50.00 | 50.00 | 50.00 | 50.00 | 50.00 | 50.00 | 54.18 |
| | U-2 | 10.00 | 10.00 | 10.00 | 10.00 | 10.00 | 10.00 | 10.03 |
| Additive (V) | V-1 | 0.20 | 0.20 | 0.20 | — | 0.20 | 0.20 | — |
| | V-2 | — | — | — | — | — | — | 0.20 |
| | V-3 | — | — | — | 1.00 | — | — | 1.00 |
| | V-4 | — | — | — | — | — | — | — |

TABLE 4

| | Examples | | | | | | |
|---|---|---|---|---|---|---|---|
| | 1 | 2 | 3 | 4 | 5 | 6 | 7 |
| Resolution (unit: μm) | 50 | 30 | 50 | 50 | 50 | 30 | 5 |
| CTE (unit: 1/K) | 55.24 | 53.87 | 54.78 | 54.39 | 53.72 | 70.86 | 98.70 |
| Tg (unit: ° C.) | 322.26 | 315.95 | 307.21 | 307.98 | 290.7 | 293.1 | 371.4 |
| | Examples | | | | | | |
| | 8 | 9 | 10 | 11 | 12 | 13 | |
| Resolution (unit: μm) | 10 | 5 | 3 | 14 | 10 | 5 | |
| CTE (unit: 1/K) | 55.23 | 38.61 | 39.91 | 75.37 | 54.39 | 34.65 | |
| Tg (unit: ° C.) | 288 | >400 | >400 | 373.54 | 307.98 | 384.26 | |
| | Comparative examples | | | | | | |
| | 1 | 2 | 3 | 4 | 5 | 6 | 7 |
| Resolution (unit: μm) | N/A | N/A | N/A | N/A | N/A | N/A | N/A |
| CTE (unit: 1/K) | 58.59 | 62.16 | 94.20 | 37.62 | 44.56 | 55.73 | 56.30 |
| Tg (unit: ° C.) | >400 | 301.54 | >400 | 377.31 | >400 | 258.11 | 369.93 |

″N/A″ means the pattern cannot be distinguished.

TABLE 5

| | Examples | | | | | | | | | |
|---|---|---|---|---|---|---|---|---|---|---|
| | 1 | 2 | 3 | 4 | 5 | 6 | 7 | 8 | 9 | 10 |
| Elongation | 7.0 | 11.0 | 8.0 | 5.3 | 9.0 | 4.3 | 1.6 | 11.0 | 2.8 | 6.1 |
| (unit: %) | | | | | | | | | | |

| | Comparative examples | | | | | | |
|---|---|---|---|---|---|---|---|
| | 1 | 2 | 3 | 4 | 5 | 6 | 7 |
| Elongation | Not | Not | Not | Not | Not | Not | Not |
| (unit: %) | measured. | measured. | measured. | measured. | measured. | measured. | measured. |

″Not measured″ means the resolution, CTE and/or Tg of the comparative example were poor, so the elongation was not measured.

### <Evaluation Methods>

a. Resolution

The prepared cured product (thickness: 10 μm) was observed via a Field Emission Scanning Electron Microscope (Model: SU8000, manufactured by Hitachi Co., Ltd.) at a magnification of 500× to 5000× to observe the clarity of the pattern and measure its width to evaluate resolution. When the resolution was less, the cured product has good resolution.

b. Coefficient of Thermal Expansion (CTE)

The coefficient of thermal expansion (CTE) of the prepared cured product (thickness: 10 km) was measured via a Thermomechanical Analyzer (Model: TMA Q400, manufactured by TA Instruments) with a preload force of 0.05 N. When the CTE was less, the cured product has good ability to resist a phase change.
Heating rate: 10° C./min
Temperature range: 280° C. to 400° C.
   c. Glass Transition Temperature (Tg)

The glass transition temperature (Tg) of the prepared cured product (thickness: 10 μm) was measured via a Thermomechanical Analyzer (Model: TMA Q400, manufactured by TA Instruments) with a preload force of 0.05 N. In the second temperature rise (2nd-run), the value of the glass transition temperature at the intermediate point was used as Tg. When the Tg was large, the cured product has good ability to resist a phase change.
Heating rate: 10° C./min
Temperature range: 280° C. to 400° C. (heating, cooling, heating)
   d. Elongation

The elongation of the prepared cured product (thickness: 10 μm) was measured via a Universal Tensile Testing Machine (Model: TPP-D500, manufactured by Pin Tai Technology CO., LTD.) with a load cell of 10 kg and a preload force of 10 g. Stretching at a rate of 10 millimeters per minute (mm/min). When the elongation was large, the cured product has good tensile strength.

### <Evaluation Results>

As may be seen from Tables 2 to 5, the cured products prepared by the photosensitive resin composition formed by the polyimide precursor including the main chain and branch having specific structure, wherein the polyimide precursor does not include fluorine and the molar ratio of the tetracarboxylic dianhydride (A) to the diamine (B) is from 1:0.95 to 1:1.10 (Examples 1 to 13), have good resolution, coefficient of thermal expansion, glass transition temperature and elongation, and may be suitable for a semiconductor device and a display device.

In addition, the cured products prepared by the photosensitive resin composition formed by the polyimide precursor obtained from the tetracarboxylic dianhydride (A), the diamine (B), and the hydroxyl-containing alkyl (meth)acrylate (C) through polymerization reaction, wherein the tetracarboxylic dianhydride (A) includes at least one of 3,3′,4,4′-diphenyl ether tetracarboxylic dianhydride, 2,3,6,7-naphthalenetetracarboxylic dianhydride, 3,3′,4,4′-diphenylsulfonetetracarboxylic dianhydride, p-phenylenebis(trimellitate anhydride)), cyclobutane-1,2,3,4-tetracarboxylic dianhydride, 1,2,4,5-cyclohexanetetrcarboxylic dianhydride, 3,3′,4,4′-decahydrobiphenyltetracarboxylic dianhydride, bicyclo[2.2.2]oct-7-ene-2,3,5,6-tetra-carboxylic dianhydride, bicyclo[2.2.2]octane-2,3,5,6-tetracarboxylic dianhydride and 3,3′,4,4′-biphenyltetracarboxylic dianhydride, and the polyimide precursor does not include fluorine (Examples 1 to 13), have good resolution, coefficient of thermal expansion, glass transition temperature and elongation, and may be suitable for a semiconductor device and a display device.

In addition, based on the total usage amount of 100 parts by weight of the photosensitive resin composition, compared to the cured product (Comparative examples 1 to 3 and 5 to 6) prepared by the photosensitive resin composition formed by the polyimide precursor for which the usage amount of the polyimide precursor is more than 34.5 parts by weight, the cured products (Examples 1 to 13) prepared by the photosensitive resin composition formed by the polyimide precursor for which the usage amount of the polyimide precursor is 24.0 parts by weight to 34.5 parts by weight have better resolution and good coefficient of thermal expansion, glass transition temperature and elongation at the same time. Therefore, when the usage amount of the polyimide precursor is 24.0 parts by weight to 34.5 parts by weight, the cured product formed by the photosensitive resin composition may have better resolution and good coefficient of thermal expansion, glass transition temperature and elongation, and may be suitable for a semiconductor device and a display device.

Based on the above, when the polyimide precursor of the invention includes the main chain and branch having specific structure, the polyimide precursor does not include fluorine and the molar ratio of the tetracarboxylic dianhydride (A) to the diamine (B) is from 1:0.95 to 1:1.10, the cured products prepared by the photosensitive resin composition including thereof have good resolution, coefficient of thermal expansion, glass transition temperature and elongation, and may be applied to a semiconductor device and a display device, thus improving the performance of a semiconductor device and a display device.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A polyimide precursor, obtained from a tetracarboxylic dianhydride (A), a diamine (B), and a hydroxyl-containing alkyl (meth)acrylate (C) through ring-opening substitution and polymerization, the polyimide precursor does not contain fluorine,
wherein the tetracarboxylic dianhydride (A) and the diamine (B) form a main chain, the hydroxyl-containing alkyl (meth)acrylate (C) is grafted to the main chain to form a branch,
and a molar ratio of the tetracarboxylic dianhydride (A) to the diamine (B) is from 1:0.95 to 1:1.10.

2. The polyimide precursor according to claim 1, wherein the tetracarboxylic dianhydride (A) comprises at least one of 3,3′,4,4′-diphenyl ether tetracarboxylic dianhydride, 2,3,6,7-naphthalenetetracarboxylic dianhydride, 3,3′,4,4′-diphenylsulfonetetracarboxylic dianhydride, p-phenylenebis(trimellitate anhydride)), cyclobutane-1,2,3,4-tetracarboxylic dianhydride, 1,2,4,5-cyclohexanetetrcarboxylic dianhydride, 3,3′,4,4′-decahydrobiphenyltetracarboxylic dianhydride, bicyclo[2.2.2]oct-7-ene-2,3,5,6-tetra-carboxylic dianhydride, bicyclo[2.2.2]octane-2,3,5,6-tetracarboxylic dianhydride and 3,3′,4,4′-biphenyltetracarboxylic dianhydride.

3. The polyimide precursor according to claim 1, wherein the diamine (B) comprises at least one of 4,4′-diaminobiphenyl, p-phenylenediamine, 4,4′-oxydianiline, 2-methyl-4,4′-oxydianiline, cyclohexane-1,4-diamine, bis(4-aminocyclohexyl)methane, 1,3-bis(3-aminopropyl)-1,1,3,3-tetramethyldisiloxane and 1,9-diaminononane.

4. The polyimide precursor according to claim 1, wherein the hydroxyl-containing alkyl (meth)acrylate (C) comprises at least one of hydroxyethyl (meth)acrylate and glycerol 1,3-dimethacrylate.

5. The polyimide precursor according to claim 1, wherein a molar ratio of the tetracarboxylic dianhydride (A) to the hydroxyl-containing alkyl (meth)acrylate (C) is from 1:0.6 to 1:2.1.

6. A polyimide precursor, obtained from a tetracarboxylic dianhydride (A) and a diamine (B) through polymerization reaction, the polyimide precursor does not contain fluorine, comprising a structural unit represented by the following Formula (1): 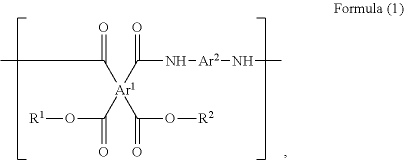
in Formula (1), Ar¹ indicates a tetravalent organic group,
Ar² indicates a divalent organic group,
R¹ and R² each indicate H, 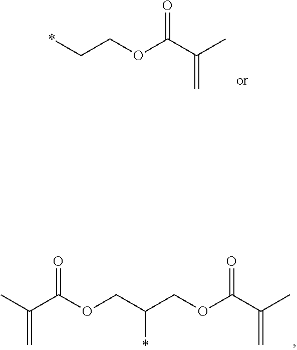
* indicates a bonding position,
wherein a molar ratio of the tetracarboxylic dianhydride (A) to the diamine (B) is from 1:0.95 to 1:1.10.

7. The polyimide precursor according to claim 6, wherein Ar¹ indicates 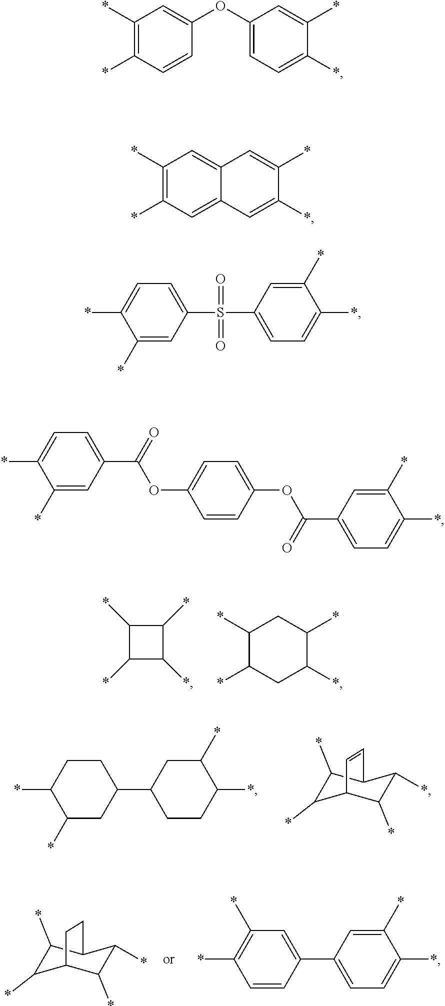
*indicates a bonding position.

8. The polyimide precursor according to claim 6, wherein Ar² indicates 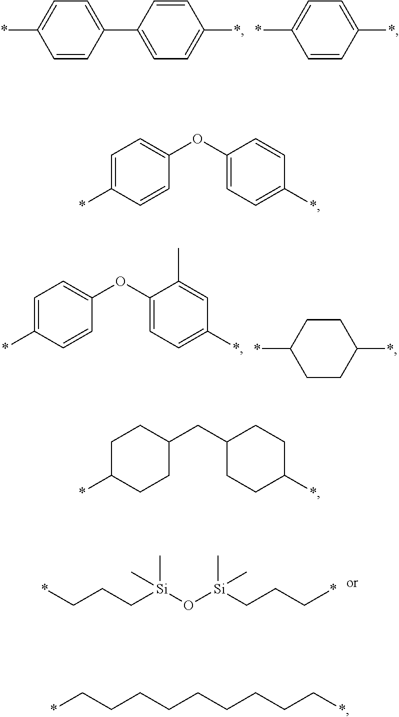
* indicates a bonding position.

9. The polyimide precursor according to claim 6, wherein R¹ and R² each indicate 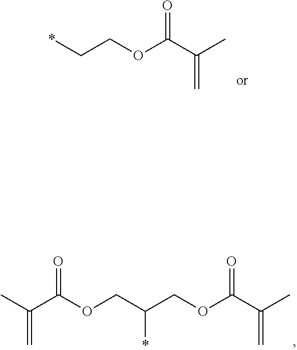
indicates a bonding position.

10. The polyimide precursor according to claim 6, wherein based on a molar fraction of 100% of a tetracarboxylic dianhydride functional group, a total molar fraction of R¹ being 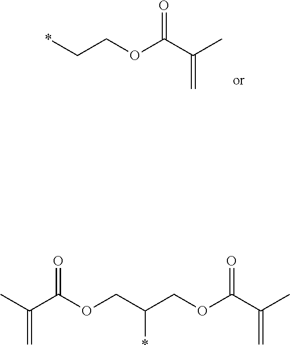
and/or R² being 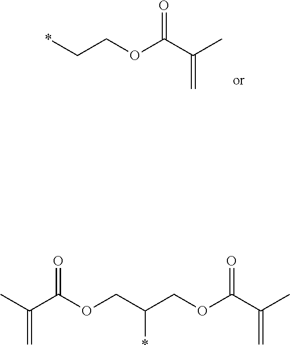
is 30% to 100%.

11. A preparation method of a polyimide precursor, comprising:
performing a ring-opening substitution reaction with a tetracarboxylic dianhydride (A) and a hydroxyl-containing alkyl (meth)acrylate (C); and
adding a diamine (B) to perform a polymerization reaction;
wherein the tetracarboxylic dianhydride (A) and the diamine (B) form a main chain, the hydroxyl-containing alkyl (meth)acrylate (C) is grafted to the main chain to form a branch,
a molar ratio of the tetracarboxylic dianhydride (A) to the diamine (B) is from 1:0.95 to 1:1.10, and
the polyimide precursor does not contain fluorine.

12. The preparation method of a polyimide precursor according to claim 11, wherein the tetracarboxylic dianhydride (A) comprises at least one of 3,3′,4,4′-diphenyl ether tetracarboxylic dianhydride, 2,3,6,7-naphthalenetetracarboxylic dianhydride, 3,3′,4,4′-diphenylsulfonetetracarboxylic dianhydride, p-phenylenebis(trimellitate anhydride)), cyclobutane-1,2,3,4-tetracarboxylic dianhydride, 1,2,4,5-cyclohexanetetrcarboxylic dianhydride, 3,3′,4,4′-decahydrobiphenyltetracarboxylic dianhydride, bicyclo[2.2.2]oct-7-ene-2,3,5,6-tetra-carboxylic dianhydride, bicyclo[2.2.2]octane-2,3,5,6-tetracarboxylic dianhydride and 3,3′,4,4′-biphenyltetracarboxylic dianhydride.

13. The preparation method of a polyimide precursor according to claim 11, wherein the diamine (B) comprises at least one of 4,4′-diaminobiphenyl, p-phenylenediamine, 4,4′-oxydianiline, 2-methyl-4,4′-oxydianiline, cyclohexane-1,4-diamine, bis(4-aminocyclohexyl) methane, 1,3-bis(3-aminopropyl)-1,1,3,3-tetramethyldisiloxane and 1,9-diaminononane.

14. The preparation method of a polyimide precursor according to claim 11, wherein the hydroxyl-containing alkyl (meth)acrylate (C) comprises at least one of hydroxyethyl (meth)acrylate and glycerol 1,3-dimethacrylate.

15. The preparation method of a polyimide precursor according to claim 11, wherein a molar ratio of the tetracarboxylic dianhydride (A) to the hydroxyl-containing alkyl (meth)acrylate (C) is from 1:0.6 to 1:2.1.

16. A photosensitive resin composition, comprising the polyimide precursor according to claim 1.

17. The photosensitive resin composition according to claim 16, wherein based on a total usage amount of 100 parts by weight of the photosensitive resin composition, a usage amount of the polyimide precursor is 5 parts by weight to 40 parts by weight.

18. The photosensitive resin composition according to claim 16, further comprising at least one of a photoinitiator, a crosslinking monomer, a leveling agent, an adhesion promoter, a solvent and an additive.

19. The photosensitive resin composition according to claim 18, wherein based on a usage amount of 100 parts by weight of the polyimide precursor, a usage amount of the photoinitiator is 1 part by weight to 30 parts by weight, a usage amount of the crosslinking monomer is 1 part by weight to 50 parts by weight, a usage amount of the solvent is 170 parts by weight to 2000 parts by weight.

20. A cured product formed by the polyimide precursor according to claim 1.
